(19) United States
(12) Patent Application Publication
(10) Pub. No.: US 2016/0381101 A1
(43) Pub. Date: Dec. 29, 2016

(54) METHOD AND APPARATUS FOR STREAMING MEDIA

(71) Applicant: ONWARDS MEDIA GROUP PTE LTD, Singapore (SG)

(72) Inventor: Yee Lok Eric TSE, Yuen Long (HK)

(21) Appl. No.: 15/194,487

(22) Filed: Jun. 27, 2016

Related U.S. Application Data
(60) Provisional application No. 62/185,517, filed on Jun. 26, 2015.

(51) Int. Cl. H04L 29/06

(52) U.S. Cl. CPC H04L 65/4076; H04L 65/1023; H04L 65/1073

(57) ABSTRACT

The present invention relates to a method and apparatus for streaming media content between nodes on a network (10). The method comprises storing data of media content in a local memory buffer in storing nodes (120, 122) as data packets; issuing a request from a target node (130) to one or more of the plurality of storing nodes (120, 122) for data packets; determining at the target node (130) a value representative of the quality of each of the storing nodes, wherein the determined value is at least partly referable to the relative number of data packets requested of a storing node (120, 122) relative to the number of requested data packets received from the storing node (120, 122); and using the determined value of the at least one storing nodes (120, 122) to decide which of the storing nodes are to be requested for subsequent data packets.

### FIELD OF THE INVENTION

The present invention relates to a system, method and apparatus for streaming media, for example, peer to peer video streaming, with adaptive quality of service control.

### BACKGROUND OF THE INVENTION

Video content providers are required to transform video signals, such as satellite video feeds, into Internet packets in data centres before the video can be streamed to end users. Video streaming requires high network bandwidth and throughput from the data centres in order to stream video with acceptable quality, i.e. low packet loss, non-jitter and low delay streams, to a large number of end users. Video content service providers are required to invest in huge and expensive data centre infrastructures in order to service a large number of concurrent end users.

In an existing peercasting system, each of the nodes treats all peers with the relevant content equally without considering the relative performances of the peers. A disadvantage of such a peercasting system is that the system does not achieve a scalable performance in live video streaming because the performance of each node may differ and resources would be wasted to request for data from heavily loaded nodes as opposed to lightly loaded nodes. The existing peercasting system is not able to scale horizontally by duplicating the number of sources to the peercasting systems.

It is an object of the present invention to provide an improved media streaming system and method and apparatus over a communication network, such as the Internet.

### SUMMARY OF THE INVENTION

In a first aspect, the present invention provides a method of streaming media content between nodes on a network comprising: a) storing data of media content in a local memory buffer in a plurality of storing nodes, wherein the data is stored as one or more data packets; b) issuing a request from a target node to one or more of the plurality of storing nodes for one or more data packets; c) determining at the target node a value representative of the quality of each of the one or more of the plurality of storing nodes, wherein the determined value is at least partly referable to the relative number of data packets requested of a storing node relative to the number of requested data packets received from the storing node; and d) using the determined value of the at least one or more storing nodes to decide which of the plurality of storing nodes are to be requested by the target node for subsequent data packets.

Advantageously, the target node using the determined value for the one or more storing nodes to determine which storing nodes to send subsequent data packet requests, the target node creates the requests of data packets from the storing nodes according to the quality of storing nodes thereby increasing the efficiency, rates of success of requests of data packets and scalability of the nodes in the network. Due to the scalability of the present invention, it provides an economical solution to streaming live video to a large number of users comparing to the data centre solution. The present invention may advantageously be used for delivering streaming video over various communication networks, including a local loop where network bandwidth and throughput are limited, and achieving a low time delay. A further advantage is that the present invention may be used to stream live video feeds, such as satellite and terrestrial television signals. Hence, for long distance broadcasts, live video feeds may be relayed through satellites first and delivered using the present invention locally to avoid using the Internet backbone, thereby avoiding congestion.

The method may periodically determine the value representative of the quality of each of the one or more of the plurality of storing nodes at the target nodes to refresh the determined value of storing nodes continuously.

The method may periodically requesting one or more data packets from one or more storing nodes by the target node and determining the value representative of the quality of each of the one or more of the plurality of storing nodes after each request for the one or more data packets to provide timely update of calculated values of storing nodes.

The number of data packets requested from a storing node by the target node may be proportional to the calculated value to enhance the rates of success of retrieval of data packets from the storing nodes.

The method may further comprise registering one or more storing nodes with a server on the network by providing details to the server of the media content to which the stored data packets relate and the IP address of the one or more storing nodes so that a target node can discover one or more storing nodes that store data packets relating to the media content to increase the scalability of storing nodes.

The method may further comprise the target node querying the registration server for details of one or more storing nodes storing data relating to a desired media content to allow a target node to request data from different storing nodes with the same media content.

The method may further comprise each storing node assigning each data packet stored in the local memory buffer with a sequence number for identification of data packets.

The method may further comprise storing a transport stream counter at the registration server for a data packet received from a first storing node to register with the registration server in respect of a given media content and the corresponding sequence number of the data packet assigned by the first storing node to register with the registration server; a second storing node requesting a sequence number for a given transport stream counter corresponding to a data packet stored by the second storing node; the registration server determining a sequence number for the given transport stream counter of the second storing node and transmitting the sequence number to the second storing node; and the second storing node assigning the received sequence number to the data packet to which the given transport stream counter corresponds. The data packets in the storing nodes may then be synchronised through the registration server based on the transport stream counter.

The method may further comprise receiving media content data by one or more of the storing nodes from an originating source so that the storing nodes may form load balancing or fault-tolerance counterparts for each other.

The originating source may be a satellite, and the method of streaming media content can be used for distribution of media content through the local loop while using a satellite link covering majority of the distance of the broadcast.

More than one storing nodes may receive media content data via satellite so that the storing nodes can form load balancing or fault-tolerance counterparts for receiving the satellite signal.

The method may further comprise connecting one or more storing nodes to a corresponding satellite feed.

The method may further comprise the target node ranking the one or more storing nodes according to the determined value of each of the one or more storing nodes and sending data packet requests to the one or more storing nodes in order of ranking in order to enhance the rate of success of data packet requests by requesting the data packets from storing nodes with higher quality values.

The number of data packets requested from each of the one or more storing nodes may be dependent upon the determined value to enhance the rate of success of data packet requests by requesting a higher number of data packets from storing nodes with higher quality values.

The method may further comprise the step of the target node requesting data packets from one or more different storing nodes of the plurality of storing nodes when the determined value of the one or more storing nodes falls below a threshold value thereby allowing the target node to forgo non-performing storing nodes in favour of other storing nodes.

The determined value for the one or more storing nodes may be further based upon the number of nodes each of the one or more storing nodes is supplying with data packets as another parameter for determining the quality of the storing nodes.

The method may further comprise the target node storing data of media content in a local memory buffer in the form of one or more data packets received from the one or more storing nodes so that the target node is operable serve other nodes with the data packets and thereby perform the function of a storing node.

In a second aspect, the present invention provides an apparatus for streaming media content, comprising memory, one or more processors, one or more network interfaces, one or more modules stored in memory and configured for execution by the one or more processors, the one or more modules comprising instructions for: a) requesting data packets from a first further apparatus for streaming media content; b) determining a value of the first further apparatus for streaming media content at least partly based on the number of data packets requested of the first further apparatus for streaming media content relative to the number of requested data packets received from the first further apparatus for streaming media content over a period of time; c) storing the received data packets in a local memory buffer; d) listening to a port of the network interface awaiting for requests of data packets from a second corresponding apparatus; and e) sending the requested data packets to the second further apparatus for streaming media content. The fact that the apparatus calculates a quality value of the corresponding apparatus based on the number of data packets requested of the corresponding apparatus relative to the number of requested data packets received from the corresponding apparatus over a period of time and requests data packets from the corresponding apparatus enhances the rates of success of requests of data packets.

In a third aspect, the present invention provides a system for streaming media content between nodes on a network, the system comprising: a) a plurality of storing nodes storing media content data in a local memory buffer in the form of one or more data packets so that the storing nodes are operable to serve other nodes with the data packets; b) a target node is operable to request one or more data packets from one or more of the plurality of storing nodes; c) wherein the target node determines and stores in memory a quality of service value relating to the quality of each of the one or more storing nodes, said quality of service value being at least partly based upon the number of data packets requested of a storing node relative to the number of requested data packets received from the storing node; and d) the target node is operable to use the determined quality of service value for the one or more storing nodes to determine which storing nodes to send subsequent data packet requests. The fact that the apparatus uses quality of service values for making requests from other apparatus enhances the performance of the system in distributing media content.

Two or more apparatus may be configured to receive data from an originating source for load balancing or fault-tolerance of the apparatus.

The originating source may be a satellite for receiving an originating video feed from a long distance.

### BRIEF DESCRIPTION OF THE DRAWINGS

Preferred embodiments of the present invention will be explained in further detail below by way of examples and with reference to the accompanying drawings, in which:—

FIG. 1 shows a communication network comprising a registration server, a source node and two target nodes;

FIG. 2 shows software modules of the source node shown in FIG. 1;

FIG. 3 shows software modules of a target node shown in FIG. 1;

FIG. 4 shows software modules of the registration server shown in FIG. 1;

FIG. 5 shows a data packet structure of a data packet implemented in the present invention;

FIG. 6 shows a message flow diagram between a source node and a target node;

FIG. 7 shows the header of a request data packet;

FIG. 8 shows the header of a response data packet;

FIG. 9 shows a graphical representation of the memory buffer of a node;

FIG. 10 shows a flow diagram of steps of processing of a satellite DVB-S2 signal by the source node shown in FIG. 1;

FIG. 11 shows a flow diagram of the steps of processing a request data packet by a source node;

FIG. 12 shows a schematic diagram of the scheduling mechanism of a source node;

FIG. 13 shows a communication network comprising a registration server, two source nodes and two target nodes;

FIG. 14 shows a registration message flow diagram of two source nodes and a registration server;

FIGS. 15 and 16 show diagrams of request formation by a target node;

FIG. 17 shows a communication network comprising eight source nodes and one target node; and

FIG. 18 shows the message flow diagram for feed discovery.

### DETAILED DESCRIPTION OF THE PREFERRED EMBODIMENTS

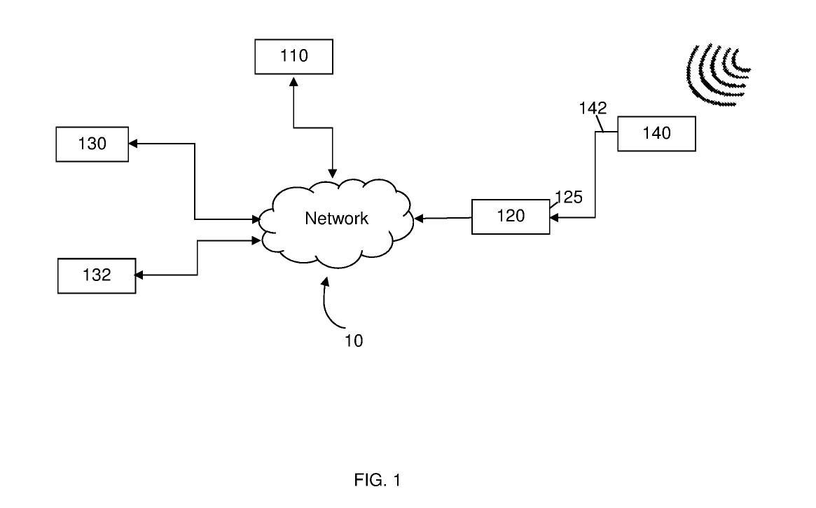

Referring to FIG. 1, there is shown a communication network 10 comprising a registration server (REGSR) 110 and three nodes, namely, a source node 120, a first target node 130 and a second target node 132.

The REGSR 110 is typically a hardware computer and includes a storage means, a memory controller, one or more processing units (CPUs), a radio frequency circuitry for transmission and receipt of wireless signals and/or a network interface with a communication port, such as RJ45 socket. These components are arranged to communicate with one another over one or more communication buses or signal lines. The REGSR 110 could alternatively be implemented by a cluster of computers or a data centre comprising a network interface.

The source node 120, first target node 130 and second target node 132 are each implemented by hardware which may comprise computer hardware, handheld computers, tablet computers, set top boxes, smartphone devices or the like. Each node 120, 130, 132 comprises a storage means, a memory controller, one or more processing units (CPUs), a radio frequency circuitry for transmission and receipt of wireless signals and/or a network interface with a communication port, such as RJ45 socket. The source node 120 further comprises a satellite interface 125, a decoder (not shown) comprising a demodulator and a demultiplexer for decoding a satellite DVB-S2 signal 142. The demodulator and the demultiplexer can be implemented using AVAILINK AVL6211 chipset and Amlogic S805 chipset respectively. AVALINK AVL6211 is a dual, differential, high performance, analogue to digital converters (ADC) with a built-in compensation circuit for DC offset and IQ imbalance. An RF AGC output is provided for simple gain control of the satellite tuner via an RC network. Amlogic S805 is an advanced application processor that integrates a powerful CPU/GPU subsystem and a secured FHD video CODEC engine. In the embodiment depicted, the target nodes 130, 132 each comprise one or more video signal interfaces (not shown) such as RGB output, HDMI, VGA for connecting to a television, digital monitor or the like so that a video signal can be transmitted and displayed on a screen of a suitable device. Each of the components of the respective devices are arranged to communicate with one another over one or more communication buses or signal lines.

The REGSR 110, source node 120 and target nodes 130 and 132 each comprise software modules, including an operating system and an application layer hosting other software modules. The operating system adopted can be any one of the modern operating systems, such as Windows, Unix, Linux, Apple iOS, Android, Chrome OS and any implementations or variations thereof.

The REGSR 110, source node 120, first target node 130 and second target node 132 are all connected to a wide area network, such as the Internet, so that each device can communicate with one another and transmit data between one another using User Datagram Protocol (UDP) or Transport Control Protocol (TCP) and Internet Protocol (IP).

In the preferred embodiment, UDP over IP is used, and the source node 120 and target nodes 130, 132 communicate with each other and transmit packetised MPEG-2 TS or video data through the communication network 10 using data packet messages that are encapsulated by UDP/IP packets.

The source node 120 is connected to a satellite 140 via coaxial cable or other type of connections through the satellite interface of the source node 120. The satellite 140 is configured to receive a DVB-S2 signal comprising a video feed of, for example, a live broadcast of a television show, which may be transmitted by a transmitting station over long distances by satellite link. The DVB-S2 signal 142 comprises one or more MPEG-2 TS transport streams, each of which is comprised of a number of frames relating to a video feed or channel. At the source node 120, the DVB-S2 signal is demodulated by the demodulator and demultiplexed by the demultiplexer to obtain the desired MPEG-2 TS transport stream. The MPEG-2 TS transport stream consists of a number of frames arranged in sequential order, which contain a video feed encoded using MPEG-2 TS format. In the MPEG-2 TS transport stream, each MPEG-2 TS frame contains an internal time stamp, a frame number and a packet identifier (PID). The PID is a constant value for all MPEG-2 TS frames in a transport stream. The internal time stamp is the time at which the MPEG-2 TS frame was transmitted from the transmitting station. For unique identification of a MPEG-2 TS frame, an identifier to be used in the network, TSCounter, is generated from the MPEG-2 TS frame based on the PID, internal time stamp and frame number. TSCounter is a unique string that can be generated by concatenation of the strings PID, internal time stamp and frame number or a MD5 hash of such concatenated strings.

The storage means of each of REGSR 110, source node 120 and target nodes 130, 132 on the network comprises a volatile, random access memory, and optionally a secondary non-volatile, solid-state memory, such as one or more Flash memory or solid state memory devices. The storage means of each device stores a plurality of software modules for performing various functions on the REGSR 110, source node 120 and target nodes 130, 132 respectively, and for processing data.

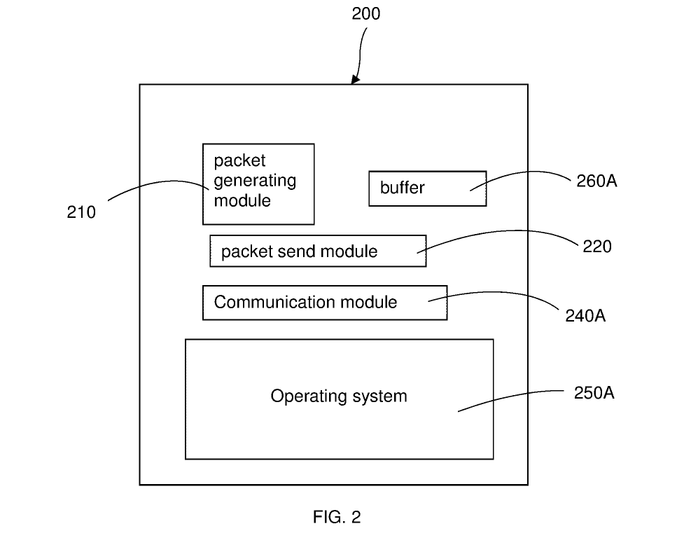

The relationships between the software modules are described below with reference to FIGS. 2, 3 and 4.

Referring to FIG. 2, the source node 120 software modules 200 comprise an operating system 250A, a communication module 240A, a packet generating module 210 and a packet send module 220. The packet generating module 210 is configured to create a second level data packet containing the data from an MPEG-2 TS frame together with media information for referencing and identification of the packets and store the second level data packets into a buffer 260A. Therefore, each sequential second level data packet stored in the buffer 260A contains corresponding data of each sequential MPEG-2 TS frame. Each second level data packet created by the packet generating module 210 is intended to be inserted into a payload of an encapsulating first level data packet. The packet send module 220 that resides in a source node is operable to wrap one or more of the second level data packets retrieved from the buffer 260A into a first level data packet for processing by the communication module 240A. The communication module 240A is configured to create a transport level response packet comprising a UDP header and a first level data packet, created by the packet send module 220, which encapsulates one or more second level data packets.

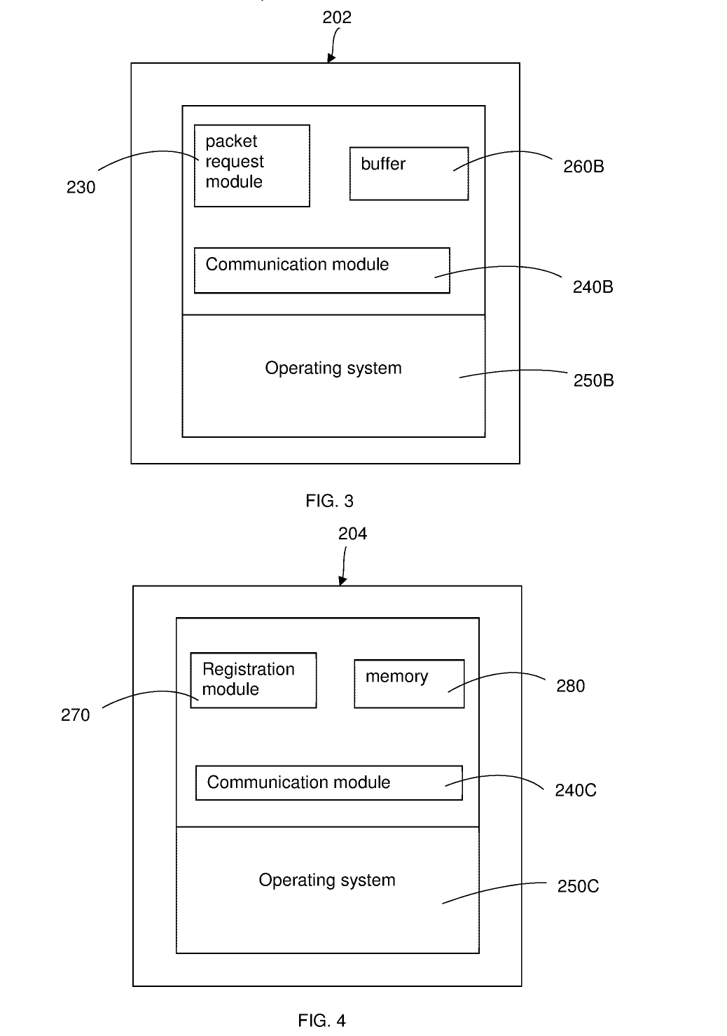

Referring to FIG. 3, the first and second target node 130, 132 software modules 202 comprise an operating system 250B, a communication module 240B and a packet request module 230. The packet request module 230 that resides in a target node is operable to create one or more first level data packets for obtaining second level data packets from one or more source nodes 120 depending on the availability of second level data packets stored in the buffer 260A of one or more source nodes 120. The communication module 240B is configured to create a transport level request packet comprising a UDP header and a first level data packet created by the packet request module 230.

Referring to FIG. 4, the REGSR 110 software modules 204 include a communication module 240C and a registration module 270, which are running on top of the operating system. The registration module 270 maintains a list of registered nodes in the communication network in memory 280, which is used for synchronization of the source nodes in a multi-source node configuration and for discovery of existing nodes by new nodes and vice versa.

The communication module 240A, 240B, 240C of each device 110, 120, 130, 132 interacts with the network interface of the respective device and is used by other software modules, such as the packet send module and the packet request module, for sending and receiving messages via the communication network.

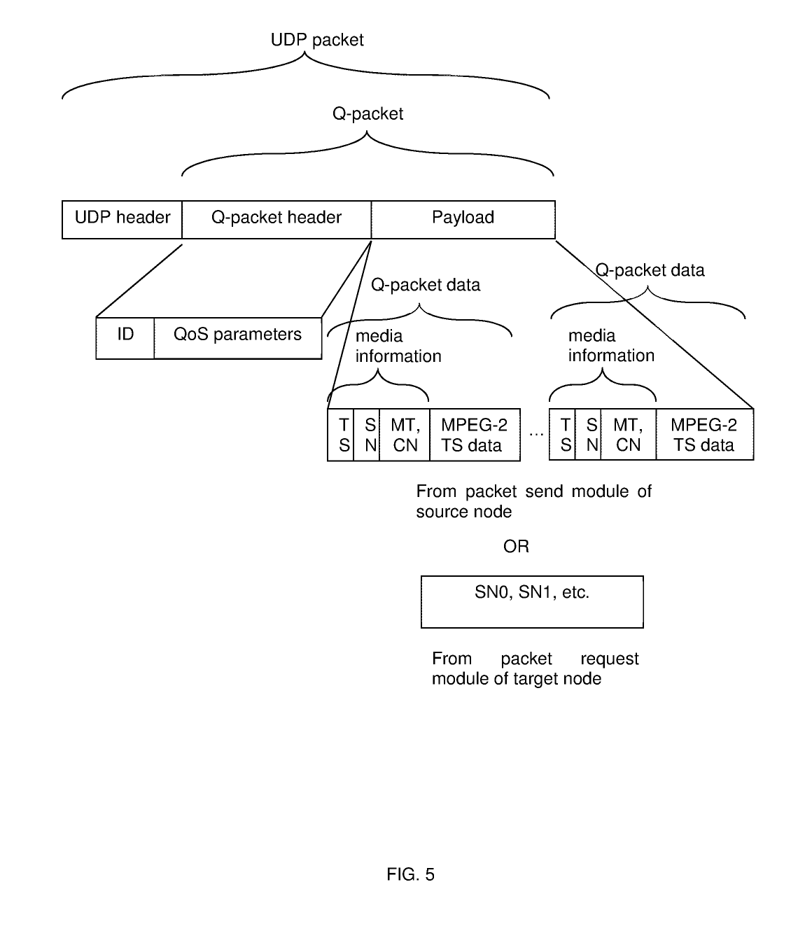

The structure of the first level data packets is further discussed by reference to FIG. 5. The first level data packets, hereinafter referred to as Q-packets, created by the packet send module 220 or the packet request module 230 comprise a payload and a ‘Q-packet’ header. The Q-packet header of a Q-packet created by the send module 220 of a source node 210 contains information relating to the source node 210 and the Quality of Source (QoS) of the source node 210 including a node ID and QoS parameters of the source node 210. The Q-packet header of a Q-packet created by the packet request module 230 of a target node 130, 132 contains information relating to the target node 130, 132 and the Quality of Service (QoS) of the node, including a node ID and QoS parameters.

In each case, the node ID is a unique identifier assigned by REGSR 110 to each of the source node 120 or target nodes 130, 132. The node ID is default to be minus one (−1), which means invalid, before assignment. Upon successful registration with REGSR 110, REGSR 110 assigns a unique, real positive number node ID to the node. The first valid node ID is 1 and each subsequent node ID is the next number in sequence, such as 2, 3, 4, etc. However, other unique identifier may also be used as the node ID.

For a response packet created by the source node 120, hereinafter referred to as Q-packet response, the payload comprises one or more second level data packets created by the packet generating module 210. In respect of a Q-packet response, the second level data packets are each hereinafter referred to as Q-packet data. Each Q-packet data comprises the MPEG-2 TS data and media information of the MPEG-2 TS data, such as a time stamp (TS), a sequence number (SN) for the Q-packet data, media type (MT) and channel name (CN). In the embodiment depicted using UDP packet as the transport protocol, a Q-packet response can hold approximately six Q-packet data in its payload. The time stamp TS is the time at which the Q-packet data is created by the packet generating module, and sequence number SN is the sequential identifier for each Q-packet data. The SN relates to the order in which each Q-packet data is generated from the video feed to which the payload data (MPEG-2 TS data) relates. For example, at time zero, the first Q-packet data will have a TS of 0.000 seconds and a SN of 0. The second Q-packet data at, say, TS of 0.001 seconds will be assigned a SN of 1 and so on.

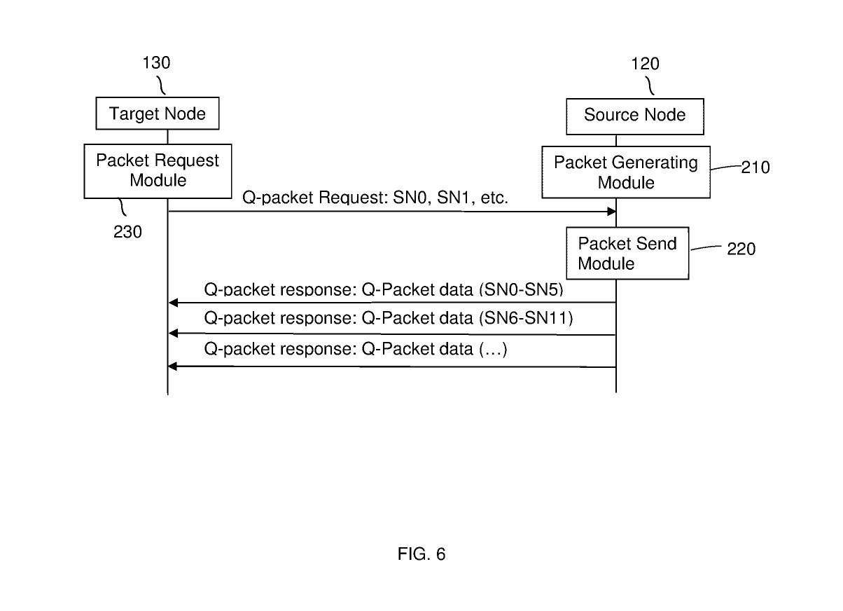

With reference to FIG. 6, for a request packet created by the target node 130, 132, hereinafter referred to as Q-packet request, the payload comprises a list of sequence numbers (SNs) to be requested from a particular source node 120. Hence, each Q-packet request may correspond to more than one Q-packet response. In the embodiment depicted, each Q-packet response carries six Q-packet data for requests of six SNs. A Q-packet request is transmitted from the target node 130 directly to the source node 120. When the source node 120 receives the Q-packet request, the packet send module 220 creates a Q-packet response by wrapping a Q-packet up, including the Q-packet data corresponding to the requested SNs, into the payload of a UDP packet as shown in FIG. 5. The UDP packet will include the transport information for the Q-packet including the destination port of the requesting target node 130, the source port of the Q-packet, the header length and a checksum.

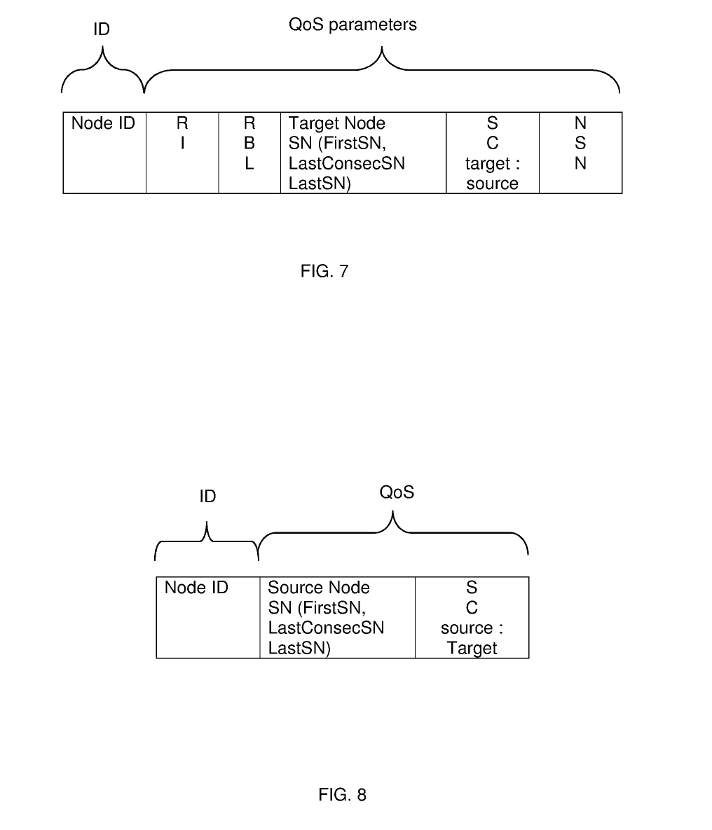

With regard to the QoS parameters, referring to FIG. 7, which shows the Q-packet request header, the target node QoS parameters to be inserted in a Q-packet request created by a target node 130, 132 comprises a request interval (RI) of the target node, a buffer level (RBL) of the target node, the sequence number of the first Q-packet data (FirstSN) contained in the buffer of the target node, the sequence number of the last consecutive Q-packet data (lastConsecSN) contained in the buffer of the target node, the sequence number of the last Q-packet data (lastSN) contained in the buffer of the target node, a score (SC target:source) of the source node with respect to the target node, and the number of source nodes (NSN) that the target node has selected in the current round of request.

The request interval RI of a target node is the time interval between Q-packet requests by a target node and thus indicates how frequently the target node sends requests for Q-packets. A high RI indicates a high quality target node as the node has low retransmission rates from the source node 120. The default value of RI is 400 milli seconds. The RI of a target node is adaptable based on the overall quality of service that it receives. A short RI means that the target node is not receiving sufficient number of Q-packets, which is indicated by buffer level RBL, or the target node has a high retransmission rate.

The buffer level RBL of the target node 130, 132 is a measure of the quantity of continuous Q-packet data stored in the buffer of the target node and, hence, how urgently the target node requires more Q-packets before the video stops. The buffer level RBL indicates the number of continuously filled Q-packet data and is equal to lastConsecSN minus firstSN. A low RBL means that the length of continuous video stored in the buffer is short, and the target node is required to shorten its RI to make more Q-packet requests.

The number of source nodes (NSN) is the number of source nodes that are currently serving a target node in the last round of Q-packet request. A high NSN means that a target node has other source nodes and higher resilience in its source of Q-packets.

The score of a source node 120 with respect to the target node 130 (SC target:source) is a ratio of the number of Q-packet requests received by the target node 130 from the particular source node 120 divided by the number of Q-packet requests sent by the target node 130 to the source node 120 over a constant time period (e.g. 5 seconds) normalised by a constant of 100. The SC target:source is therefore a ratio between 0 and 100 and is default to 100 upon initialisation of the target node. Thus, if the target node 130 sent a Q-packet request for ten Q-packets and has received ten Q-packet responses to the request from the source node 130 over the prescribed period of 5 seconds, SC target:source is 100. If, on the other hand, the target node 130 sent a Q-packet request for ten Q-packets and has not received any Q-packet response from the source node 130 within the time period, SC target:source is 0. In a further example, if the target node 130 has sent a Q-packet request for ten Q-packets and receives only five Q-packet responses from the source node 130 within the time period, SC target:source is 50. As above, since the number of Q-packets requested by a target node to a source node and number of Q-packets received from the source node will vary over time, the SC target:source for each source is stored in the local memory of the target node 100 and is dynamically updated over time.

The Q-packet header sent in a Q-packet response from a source node 120 to a target node 130, 132 is shown in FIG. 8. Similar to the parameters contained in a Q-packet header sent from a target node 130, 132 to a source node 120, the Q-packet header contains the node ID of the source node 120, the sequence number of the first Q-packet data (FirstSN) contained in the buffer of the source node, the sequence number of the last consecutive Q-packet data (lastConsecSN) contained in the buffer of the source node, the sequence number of the last Q-packet data (lastSN) contained in the buffer of the source node, and a score (SC source:target) of the target node 130, 132 with respect to the source node 120.

The score of the target node 130 with respect to the source node 120 (SC source:target) works similarly to SC target:source when the roles of the target node and the source node are swapped. SC source:target is calculated as Number of Q-packet data received from a target node divided by the Number of Q-packet data requests sent to the target node normalized by a constant of 100. SC source:target is also a ratio between 0 and 100 and is dynamically updated over time. However, SC source:target is optional and is for reference only. The SC source:target becomes useful when the roles of the target node and the source node are swapped. For instance, the roles of a target node and the source node are swapped when the source node stops receiving the video feed and the source node has to become a target node and obtain video feed (MPEG-2 TS data) from other nodes.

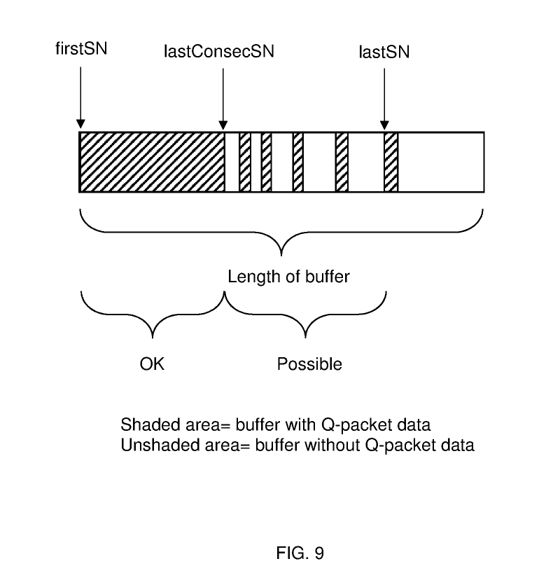

With reference to FIG. 9, the local memory buffer of a node is depicted graphically. The shaded portions of the local memory buffer represent the parts of the buffer that have video data, i.e. the SNs of the Q-packet data are available. The beginning part of the buffer that stores older video data generally is filled as a period of time has elapsed for obtaining the Q-packets. The beginning of the buffer is the Q-packet data with firstSN. The SN of the last Q-packet data that is continuously filled in the buffer is the lastConsecSN. In the example in which only one Q-packet data (SN=0 or SN0) is available in the buffer, LastConsecSN will also be 0. If two Q-packet data are available in the buffer, namely SN0 and SN1, FirstSN will be 0 and LastConsecSN will be 1. The portion of the buffer from firstSN to lastConsecSN contains the data for a continuous piece of video. The portion of the buffer after the LastConsecSN is partially filled with Q-packet data depending on the availability of the Q-packet data. The SN of the last Q-packet data that exists in the buffer is the lastSN. If, for example, the buffer contains five Q-packet data, namely SNs={0, 1, 2, 4, 5} or {SW0, SN1, SN2, SN4, SN5}, the FirstSN will be 0, the LastConsecSN will be 2 and the LastSN will be 5.

Upon receiving the firstSN, lastConsecSN and lastSN values of a source node via a Q-packet response in response to a Q-packet request, and by comparing those values against the firstSN, lastConsecSN and lastSN of the target node, the target node 130, 132 is able to determine whether the source node has any Q-packet data that the target node is missing. Hence, from the perspective of a target node 130, 132, the region of the buffer between firstSN and lastConsecSN of a source node 120 is considered as “OK” as a Q-packet request for such Q-packet data within the OK region should be available. The region of the buffer between lastConsecSN and lastSN is considered as “Possible” as a Q-packet request for such Q-packet data within the Possible region may be available depending on whether the requested SN is available at the time the request is processed by the source node. When a source node 120 is active, its buffer will be filled continuously. Therefore, the firstSN, lastConsecSN and lastSN parts of the Q-packet header of each Q-packet are dynamically updated.

Sequence numbers SN are also used for flow control between a source node 120 and a target node 130, 132. Based on the QoS parameters (FirstSN, LastConsecSN and LastSN) of both a target node 130 and a source node 120, the target node 130 is able to determine the SNs of Q-packet data available from a source node 120 and also the missing SNs that a target node 130 has not yet received. Hence, the use of the QoS parameters keeps track of the sequence of Q-packets received by the target node 130 and determines the retransmission of Q-packets.

Moreover, the time stamp TS is used for aging of packets. As Q-packets may be dropped in a communication network and take a long time to recover, in the embodiment depicted, if requested Q-packets are not received by a target node 130 for a period of time as determined based on the time stamp TS, the target node 130 will skip the lost packets and continue from the next available Q-packet. Such an implementation is useful for live video streaming where tolerance for time delay of the video is low.

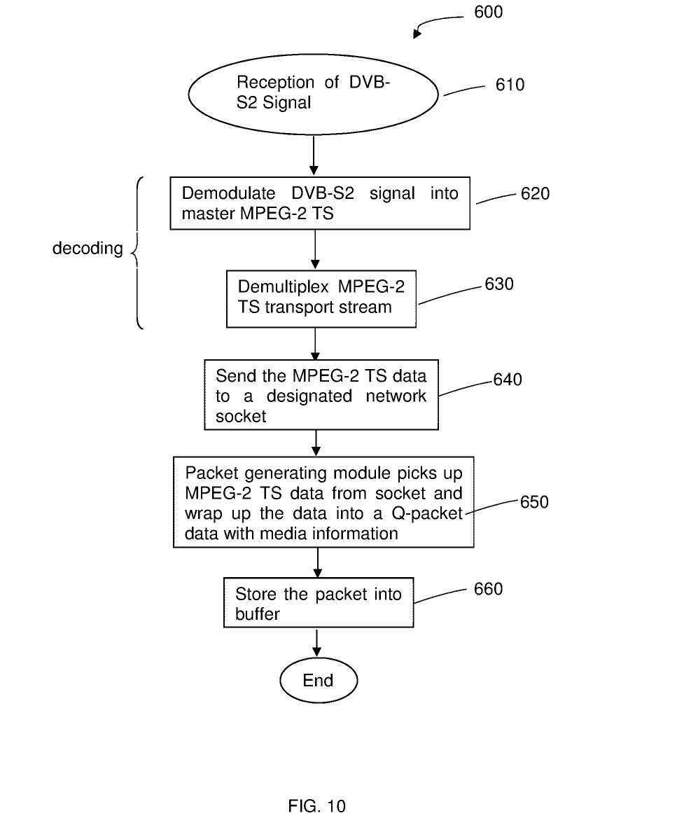

With reference to FIG. 10, the steps of processing of a satellite DVB-S2 signal by a source node 120 is described. The satellite 140 receives a wireless DVB-S2 video signal 142 of a live television broadcast and relays the signal 142 on to the source node 120 via the wired connection. The satellite interface 125 of the source node 120 receives the signal 142 and communicates the data of the signal 142 to the demodulator (610). In the demodulator, the analog DVB-S2 signal is de-encapsulated, and the master MPEG-2 TS transport stream, which contains one or more MPEG-2 TS transport streams, is obtained (620). The demultiplexer time demultiplexes the master MPEG-2 TS transport stream to obtain the MPEG-2 TS transport stream for a specific video feed, such as a channel (630). The decoded signal (i.e. the demodulated and demultiplexed signal) is in the form of a coded video transport stream (CVTS). In this embodiment, the CVTS is encoded as MPEG-2 TS transport stream, but it can be encoded by other suitable digital video formats such as MPEG-4.

The CVTS data, i.e. the MPEG-2 TS data, is sent by the demodulator to a designated socket of the source node 120 (640). The packet generating module 210, which is configured to listen to the socket, detects that the CVTS data (MPEG-2 TS data) has been transmitted to the socket and packages the CVTS data (MPEG-2 TS data) into individual Q-packet data with media information (650). The Q-packet data are stored in a buffer 260A in the source node memory (660) by the packet generating module 210. In case that both demodulator and packet generating module locate in the same hardware device, the designated socket mentioned above will be a local socket.

The source node local memory buffer stores sufficient amount of CVTS data (Q-packet data) for quality streaming of the video over the communication network. Typically, for a satellite live broadcast coded in MPEG-2 TS format, the amount of data stored in the buffer is sufficient to provide around 50 to 60 seconds of video, which has been found to provide a live non-jittery video.

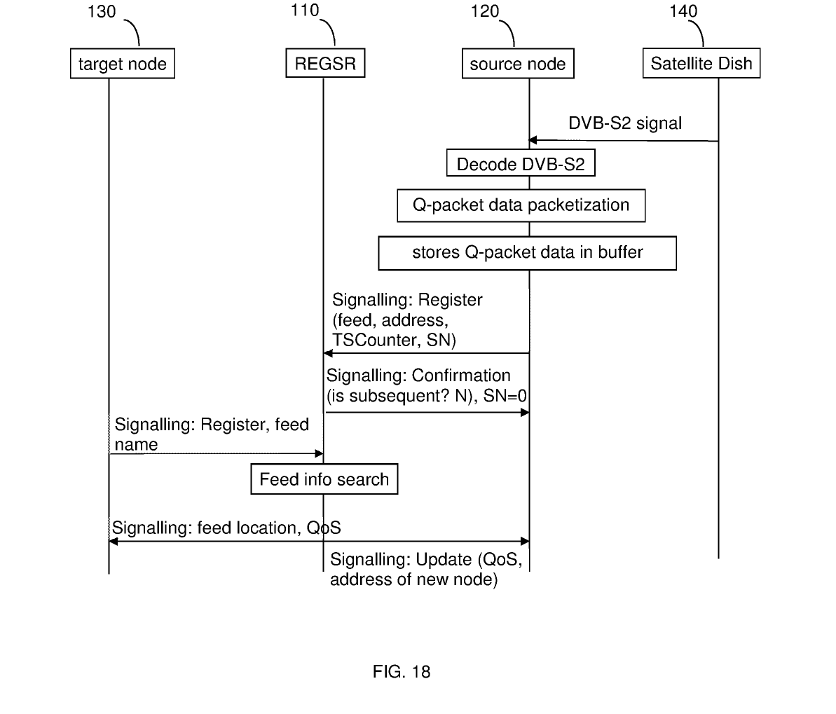

With reference to FIG. 18, the registration of source node 120 and discovery by target node 130, 132 are described. When a source node 120 starts up, the source node 120 sends a signalling message to REGSR 110 to register itself as a source node 120 that has a video feed. The signalling message contains the feed name, TSCounter, SN, the address of the source node 120 and QoS parameters of the source node.

Upon successful registration with the REGSR 110, REGSR 110 transmits a signalling message back to the source node 120 to confirm registration of the source node 120. The registration module of REGSR 110 stores details of the source node in the memory of REGSR 110 including the QoS parameters of the source node 120, the IP address of the source node 120 and the feed name supplied by the source node 120. When the source node 120 is registered with the REGSR 110, the source node 120 is available to supply Q-packet data relating to the video feed to one or more requesting target nodes.

Referring to FIG. 18, a target node 130 desiring a particular video feed generates a signalling message comprising a request for the desired video feed and transmits the signalling message to REGSR 110. In response to the video feed request, the registration module 270 looks up all source nodes registered with the REGSR 110 to identify which source nodes 120 have registered to indicate the desired video feed is available. In the embodiment depicted, only the source node 120 is registered as supplying the desired video feed. The registration module 270 sends a signalling message back to the requesting target node 130 which includes the QoS parameters of the source node 120 and the IP address of the source node 120. The requesting target node 130 is therefore provided with details of which sequence numbers the source node 120 is certain to have (FirstSN to lastConsecSN) and also details of which sequence numbers the source node 120 may have (lastConsecSN+1 to lastSN). Since the target node 130 also has the IP address of the source node 120, the target node 130 knows where to send Q-packet requests.

When the new target node 130 successfully registers with REGSR 110, REGSR 110 will send a signalling message to update all existing registered nodes, in this case the source node 120 as it is the only registered node, with QoS parameters of the target node 130 and the IP address of the target node so that the source node 120 will be aware of the existence of the newly joined target node 130. By updating all existing registered nodes when a new node registers with REGSR 110, it is possible for existing nodes registered with REGSR 110 on the network to discover new nodes from which data packets may be obtained.

It should be worth noting that although the aforementioned registration process of source nodes is preferred, other ways of registration and discovery of source nodes are available to the skilled person, including use of pre-configured host files, directories and databases with addresses of source nodes.

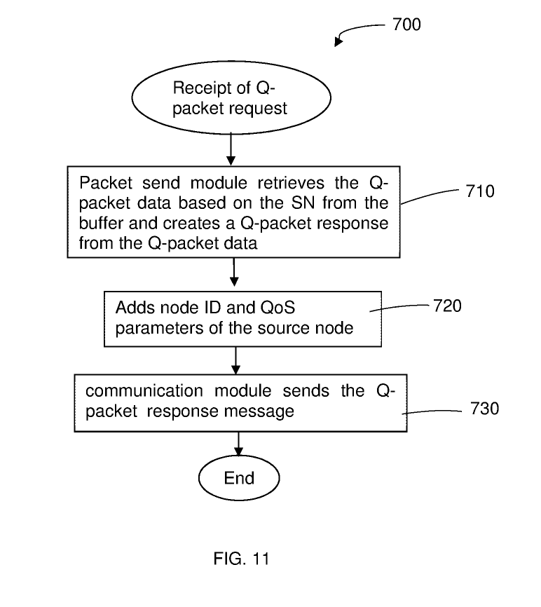

With reference to FIG. 11, the steps of serving of Q-packet requests by a source node 120 is described (700). Upon receipt of a Q-packet request from a target node 130, the packet send module 220 of the source node 120 retrieves the Q-packet data, based on the requested SNs, from the buffer 260B and creates a Q-packet response message from the Q-packet data (710). The packet send module 220 adds the node ID and QoS parameters of the source node 120 into the Q-packet header (720) of the Q-packet. The packet send module 220 uses the communication module 240B which adds a UDP header and sends the Q-packet responses via the network (730) to the requesting target node 130.

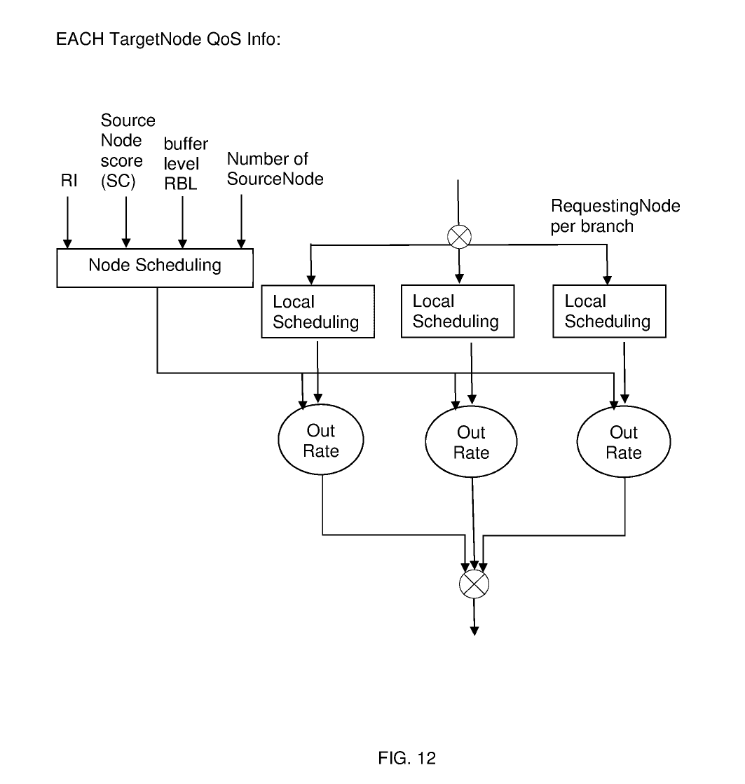

With reference to FIG. 12, the steps of scheduling by a source node 120 to target node 130, 132 are described below. Where there is more than one target node 130, 132, the source node 120 prioritises the Q-packet request of each target node 130, 132 in accordance with a scheduling scheme. The source node 120 has an output rate, which is the expected number of packets that can be sent per second (throughput in bits/second). The output rate for each of the target nodes 130, 132 is the output rate of the source node 120 divided by the number of target nodes being served by the source node 120. For each target node 130, 132, the source node 120 adjusts the output rate of the target node 130, 132 according to the following. First, if the request interval RI of a target node 130 is larger than 400 milli-seconds, the output rate of the target node 130 is reduced by 5%. Second, if the buffer level RBL of a target node 130 is larger than 50, the output rate of the target node 130 is reduced by 5%. Third, if the NSN of a target node 130 is larger than 10, the output rate of the target node 130 is reduced by 5%. The amount of reduced output rate is distributed equally to other target nodes, such as target node 132.

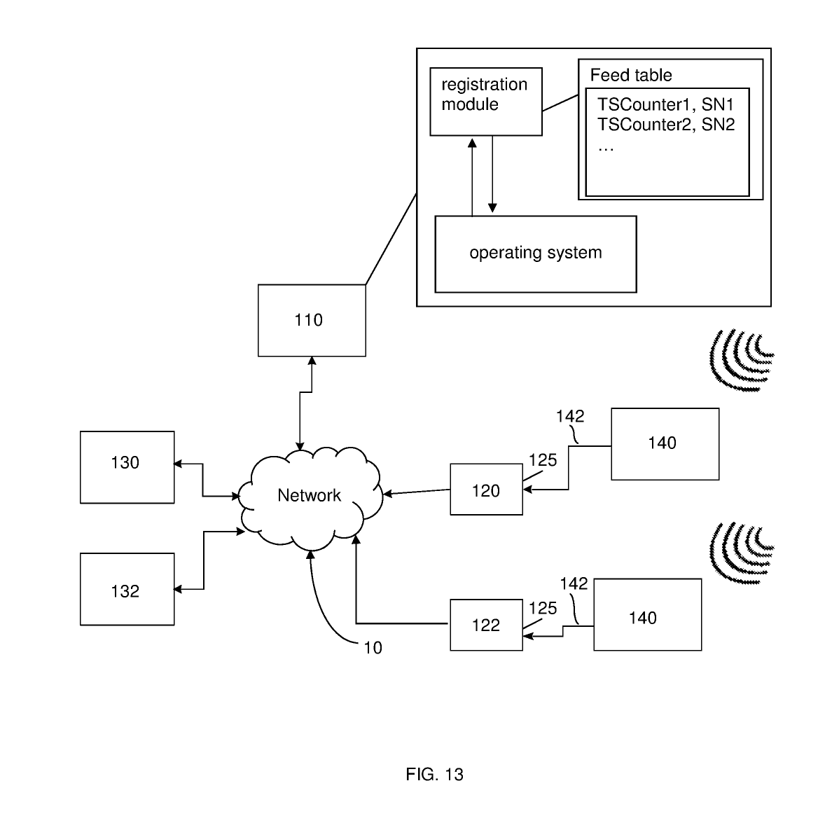

In a second embodiment of the present invention, with reference to FIG. 13, multiple source nodes 120, 122 with access to the satellite DVB-S2 signal are connected to the communication network 10. In this embodiment, the two source nodes 120, 122 form a load balancing and/or fault-tolerance pair of nodes. When all source nodes 120, 122 are providing the same video feed, the source nodes 120, 122 will share the load from the target nodes 130, 132. Also, if one of the source nodes 120 fails, the remaining source node 122 is able to continue servicing the requests of the target nodes of the failed source node 120 as a fault-tolerance counterpart. This multiple source nodes configuration provides higher scalability and resistance to single-point-of-failure to the source node.

In order for the source nodes to load balance and failover from one node to the other, the SNs used by the source nodes 120, 122 are synchronised via REGSR 110 periodically using a feed table stored in the memory of REGSR 110. The feed table contains an array of two fields, namely TSCounter and the corresponding sequence number SN.

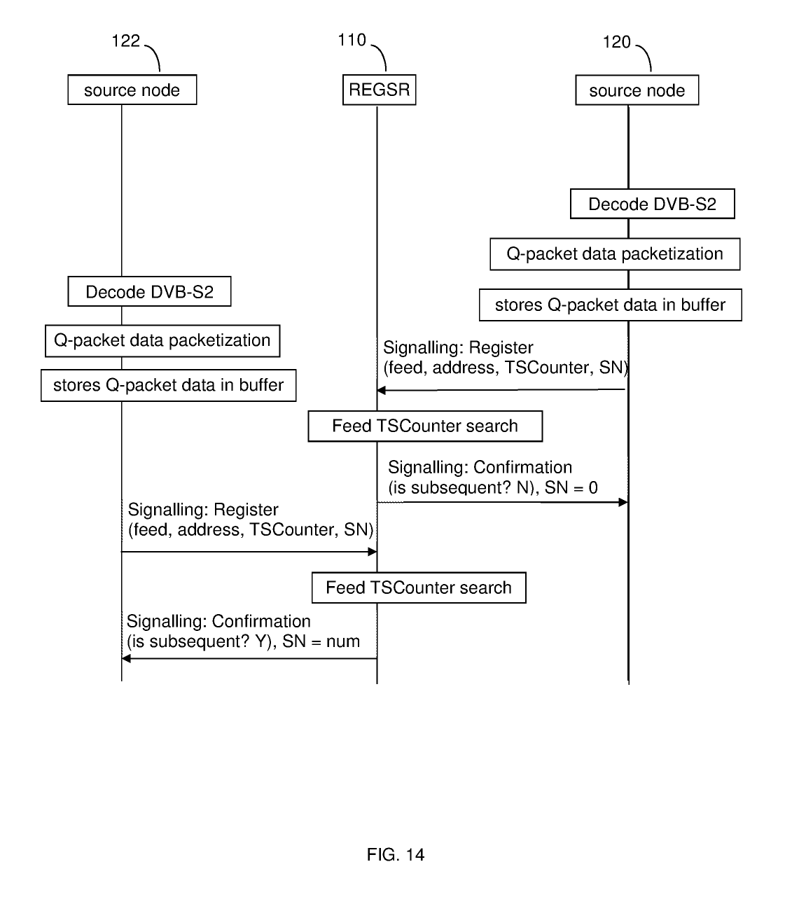

The steps of synchronisation of SNs across source nodes are the following. Referring to FIG. 14, the first source node 120 sends a signalling message to REGSR 110 to register itself as a source node that has a MPEG-2 TS transport stream with a feed name, address of the source node 120, TSCounter of the source node 120 and corresponding SN for the TSCounter. The registration module 270 of REGSR 110 will check whether the same feed name has already been registered with the TSCounter stored in the feed table. As the source node 120 is the first source node registering with the feed name, the registration module will store the TSCounter with the SN=0 in the feed table. Upon successful registration of the first source node with REGSR 110, REGSR 110 responds a signalling message and confirms registration to source node 120, and source node 120 sets the Q-packet data at time zero with SN equals to 0 and listens as a source node. Each subsequent Q-packet data created by the packet generating module 210 is assigned the next SN in sequence.

For subsequent registrations of source nodes, such as registration of source node 122, with the same MPEG-2 TS transport stream, the second source node 122 sends a signalling message to REGSR 110 to register itself as a source node that has a MPEG-2 TS transport stream with a feed name, address of the source node 122, the TSCounter of the first available data packet of the source node 122 and corresponding SN for the TSCounter. The registration module 270 of REGSR 110 checks whether the same feed name has already been registered. As it is a subsequent registration, REGSR 110 looks up from the feed table to calculate which SN corresponds to the TSCounter received from the second source node 122 and responds a signalling message and confirms registration to source node 122 with the SN from the feed table for the received TSCounter. The second source node 122 sets the Q-packet data with the specific TSCounter with the assigned SN and listens as a source node. On the other hand, if a SN cannot be found based on the TSCounter by looking up the TSCounter value in the feed table, the REGSR 110 will retry for a period of 5 seconds to catch new updates of TSCounter and SN values from the source nodes. If the TSCounter cannot be found after the retry period, the REGSR 110 will return an error to the source node 122 to deny registration.

When there is more than one source node, as described above, in order to keep SN synchronised across the source nodes of the same video feed, each of the source nodes periodically, in the embodiment depicted every five seconds, sends a signalling message to the REGSR containing the current TSCounter with the current corresponding SN to REGSR 110. For each feed name, the REGSR maintains a table of TSCounter and SN in memory, which is used for look up of SN based on TSCounter. The feed table is an array of the last updated TSCounter and SN value pairs for each of the source nodes and is an up to date list of TSCounter and SN value pairs of all active source nodes. Upon REGSR's receipt of the signalling message, the REGSR 110 sends back a confirmation message to the source node if the TSCounter is new. On the other hand, if the TSCounter already exists in the table of TSCounter, the REGSR 110 will send back a confirmation message with the corresponding SN for the TSCounter. The source node will mark SN for the Q-packet data, which corresponds to the TSCounter, and increment the SN for the subsequent Q-packet data.

Similar to the first embodiment, a second source node 122 can also register with the REGSR 110 as being able to supply Q-packets relating to the video feed. The second source node 122 can supply the target node 130 with Q-packets that the first target node 130 requires thereby further sharing the load between the nodes on the network.

Further, with the discovery of the source nodes through the REGSR 110, a second target node can send Q-packet requests to both the source node 120 and the second source node according to the mechanisms described above.

The steps for formulating the Q-packet requests for mulitple source nodes are set out below. The Q-packet requests are generated by the packet request module 230 of a target node 130. As outlined above, by comparing the firstSN and lastConsecSN parameters of the source nodes 120, 122 against the firstSN and lastConsecSn of the target node 130, the packet request module 230 of the target node 130 determines which SNs of Q-packet data are available from the source nodes 120, 122. The number of SNs of Q-packet data to be requested from the source nodes 120, 122 are determined based on the respective scores SC of the source nodes 120, 122, which represent the expected delivery rate of the source nodes 120, 122 in the last 5 seconds.

The source node SC is important for determining the qualities of the source nodes 120, 122 which enables target node 130 to identify the best and most reliable source nodes for a particular video feed. The higher the SC, the better quality of the source node and a higher number of SNs will be included in the Q-packet request. In this way, the efficiency and success rates of the Q-packet requests are then enhanced because they are based on the SC of the source nodes 120, 122. For example, when the target node 130 has two source nodes 120, 122, if the source nodes 120 and 122 have a score of 100 and 50 respectively, the target node 130 will issue twice the number of Q-packet requests to the source node 120 than the source node 122. The Q-packet requests sent by a target node 130 to the source nodes 120, 122 are continuously adjusted based on the QoS parameters of the source nodes. For example, if the score of the source node 120 drops to 50 and the score for the source node 122 increases to 100, the target node 130 will adjust its Q-packet requests so that twice the number of Q-packet requests are sent to the source node 122 than the source node 120.

In addition, a randomness factor (r) is optionally introduced to the total number of SNs to be requested so that multiple target nodes are randomised to avoid repeatedly requesting the same Q-packet data from the same source node thereby overloading a particular source node that has certain Q-packet data only. For example, if the total number of SNs for a round of request is calculated to be 10, the randomness factor r of 1 will alter the total number of SNs with a uniform distribution between 9 and 11 with a mean of 10.

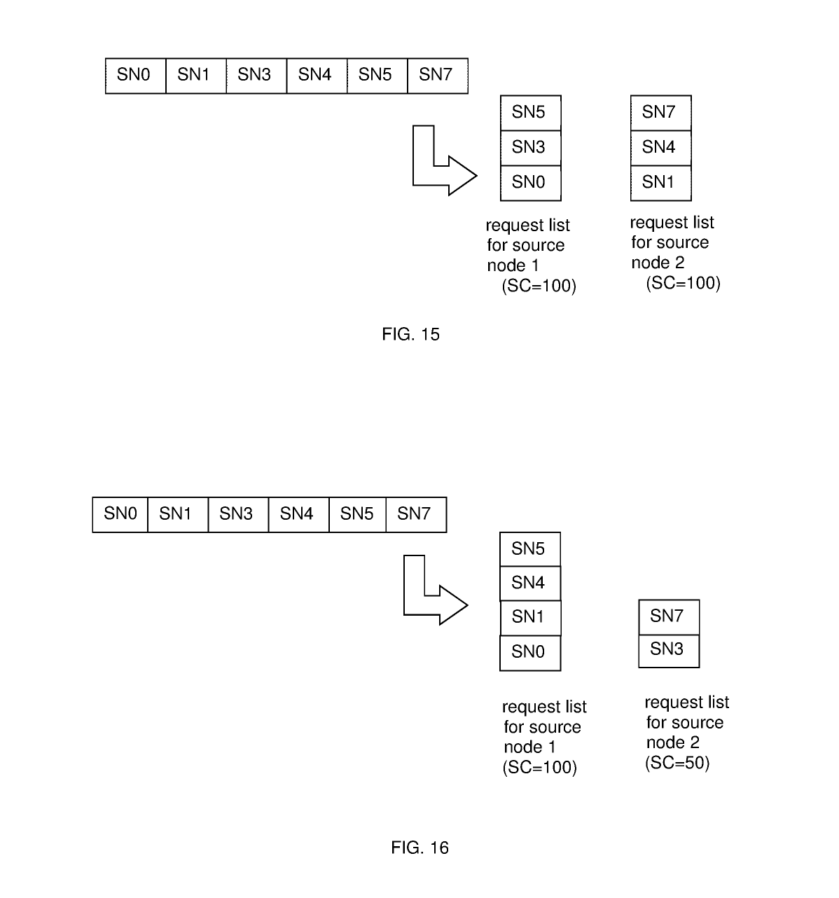

The list of SNs to be requested from each source node 120, 122 are allocated in a round robin fashion. For example, as shown in FIG. 15, if a target node is required to obtain SN0, SN1, SN3, SN4, SN5 and SN7 from source nodes 120, 122, the target node will distribute the requests for SN0, SN3 and SN5 to source node 120 and SN1, SN4 and SN7 to source node 122. In this way, the load of the source node 120 is shared approximately evenly by source node 122 apportioned based on their respective scores SC. Further to the example above in FIG. 16, if the SC of source nodes 120, 122 are 100 and 50 respectively, the target node will distribute the requests for SN0, SN1, SN4 and SN5 to source node 120 and SN3 and SN7 to source node 122.

For each source node 120, 122, the packet request module 230 of a target node 130 generates a Q-packet request header according to the format in FIG. 7 that comprising a node ID, request interval RI, buffer level RBL, firstSN, lastConsecSN and lastSN, SC target:source and NSN. The packet request module 230 then adds to the payload of the Q-packet the SNs to be requested from the source node 120, 122.

When the Q-packet requests are formed, the requests are sent by the packet request module through the communication module 240B of the target node 130 to the source nodes 120, 122.

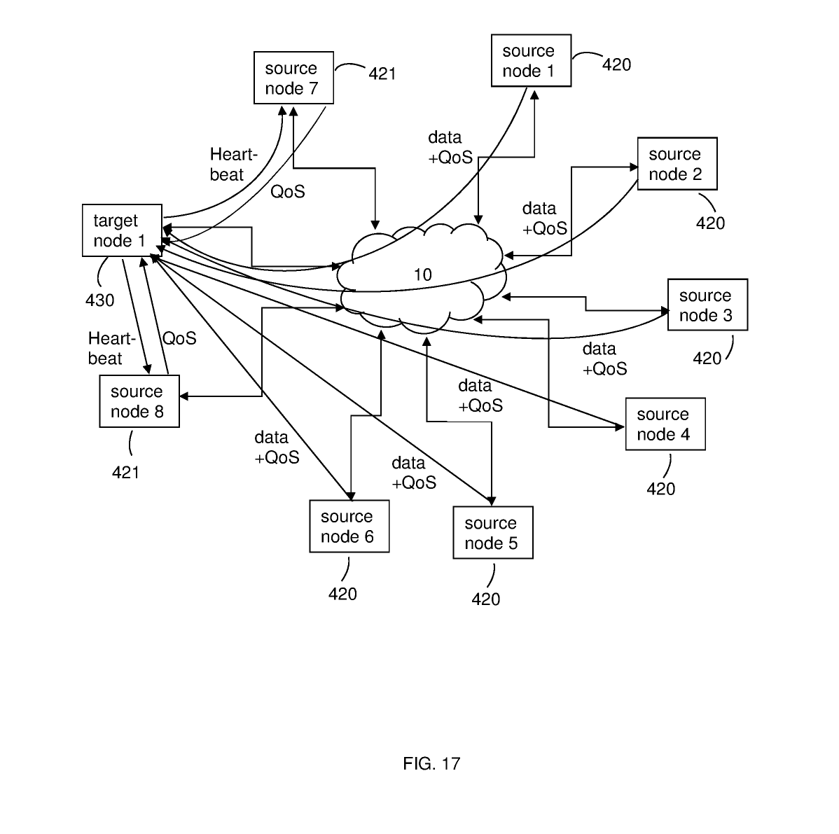

In a communication network, such as the Internet, the number of nodes in the network can be large. Referring to FIG. 17, in the third embodiment of the present invention, there is a large number of potential source nodes. In a network in which there are a large number of nodes, i.e. >10, a target node may be configured to only request data simultaneously from a maximum number of source nodes such as six source nodes. In this scenario, the target nodes 430 will have the QoS parameters of the source nodes 420 that are actively serving the target node. For the other non-active source nodes 421, the target node 430 sends “heartbeat messages” to the non-active source nodes 421 at a regular interval to find out the QoS of other source nodes and to ensure the communications channel between the target node and the non-action source nodes remains open. For the “heartbeat messages”, the message format of a Q-packet request is the same as described above in FIG. 5 except that the Q-packet does not request any SNs. The message format of a Q-packet response is also the same as described in FIG. 5 but without any Q-packet payload. Accordingly, each target node has an updated list of source nodes with their QoS parameters. Based on the algorithm described above, a target node constantly adjusts its requests of data to source nodes based on the QoS parameters of all source nodes to select the source nodes with the best QoS parameters.

Similar to the other embodiments, the Q-packet requests of a target node is continuously adjusted based on the QoS parameters of all source nodes. For example, the SCs of source node 4, 5 and 6 can indicate to the target node 430 that the quality of the source nodes are too low to obtain Q-packets from those source nodes. In the event that the SCs of these source nodes drop below a threshold, the target node 430 will drop source node 4, 5 and 6 in favour of the new source node 7 and 8. In this way, a target node 430 is constantly adjusting its source nodes based on the QoS of all available source nodes.

In the preferred embodiment of the present invention, a node may perform the function of a source node as well as a target node, and thereby become a redistribution node. In other words, each redistribution node may request and receive data from other source nodes or redistribution nodes and redistribute the data to any other requesting target nodes or redistribution nodes. A redistribution node will therefore comprise a packet request module and a packet send module. In the event the redistribution node is connected to a satellite feed, the redistribution node will also comprise a packet generating module. The choices of source nodes or redistribution nodes, as described above, are determined by the QoS parameters of the source nodes or redistribution nodes as obtained from the Q-packets or “heartbeat messages”. After the nodes join the network for a period of time, the nodes automatically stabilize with efficient interconnections between the nodes. In a network with 50 nodes, tests have shown that resource consumption of the source node that connects directly to the satellite (also referred as a satellite node) can be reduced by 80% in comparison to connecting all nodes directly to the satellite node.

A redistribution node follows the same registration mechanism as a source node and discovery mechanism as a target node as mentioned above. The redistribution node registers with the registration server upon receipt of one or more data packets from a source node or another redistribution node.

In a further embodiment of the present invention, to increase scalability, the redistribution nodes are arranged in a cascaded manner based on a hierarchy provided by REGSR 110. However, such an arrangement of nodes will cause higher delay for nodes located at the branches of the hierarchy.

The foregoing description, for purpose of explanation, has been described with reference to specific embodiments. However, the illustrative discussions above are not intended to be exhaustive or to limit the invention to precisely the embodiments disclosed. Further, while the principles of the invention have been described above in connection with specific apparatus, it is to be clearly understood that this description is merely made by way of example and not as a limitation on the scope of the invention, as defined in the appended claims.

1. A method of streaming media content data between nodes on a network comprising:
storing media content data in a local memory buffer in a plurality of storing nodes, wherein the data is stored as one or more data packets;
issuing a request from a target node to one or more of the plurality of storing nodes for one or more data packets;
determining at the target node a value representative of the quality of one or more of the plurality of storing nodes, wherein the determined value is at least partly referable to the relative number of data packets requested of a storing node relative to the number of requested data packets received from the storing node;
and
using the determined value of the at least one or more storing nodes to decide which of the plurality of storing nodes are to be requested by the target node for subsequent data packets.

2. The method for streaming media content between nodes on a network according to claim 1, further comprising periodically determining the value representative of the quality of each of the one or more of the plurality of storing nodes.

3. The method for streaming media content between nodes on a network according to claim 1, further comprising periodically requesting one or more data packets from one or more storing nodes by the target node and determining the value representative of the quality of each of the one or more of the plurality of storing nodes after each request for the one or more data packets.

4. The method for streaming media content between nodes on a network according to claim 1, wherein the number of data packets requested from a storing node by the target node is proportional to the determined value.

5. The method for streaming media content between nodes on a network according to claim 1, further comprising registering one or more storing nodes with a server on the network by providing details to the server of the media content to which the stored data packets relate and the IP address of the one or more storing nodes for discovery by a target node of one or more storing nodes that store the data packets of the media content data.

6. The method for streaming media content between nodes on a network according to claim 5, further comprising the target node querying the registration server for details of one or more storing nodes storing data of a requested media content.

7. The method for streaming media content between nodes on a network according to claim 1, further comprising each storing node assigning each data packet stored in the local memory buffer with a sequence number.

8. The method for streaming media content between nodes on a network according to claim 7 when dependent directly or indirectly upon claim 5, further comprising storing a transport stream counter at the registration server for a data packet received from a first storing node to register with the registration server in respect of a given media content and the corresponding sequence number of the data packet assigned by the first storing node to register with the registration server; a second storing node requesting a sequence number for a given transport stream counter corresponding to a data packet stored by the second storing node; the registration server determining a sequence number for the given transport stream counter of the second storing node and transmitting the sequence number to the second storing node; and the second storing node assigning the received sequence number to the data packet to which the given transport stream counter corresponds.

9. The method for streaming media content between nodes on a network according to claim 1, further comprising receiving media content data by one or more of the storing nodes from an originating source.

10. The method for streaming media content between nodes on a network according to claim 9, wherein the originating source is a satellite.

11. The method for streaming media content between nodes on a network according to claim 10, wherein more than one storing node receives media content data via satellite.

12. The method for streaming media content between nodes on a network according to claim 10, further comprising connecting one or more storing nodes to a corresponding satellite feed.

13. The method for streaming media content between nodes on a network according to claim 1, further comprising the target node ranking the one or more storing nodes according to the determined value of each of the one or more storing nodes and sending data packet requests to the one or more storing nodes in order of ranking.

14. The method for streaming media content between nodes on a network according to claim 1, wherein the number of data packets requested from each of the one or more storing nodes is dependent upon the determined value.

15. The method for streaming media content between nodes on a network according to claim 1, further comprising the target node requesting data packets from one or more different storing nodes of the plurality of storing nodes when the determined value of the one or more storing nodes falls below a threshold value.

16. The method for streaming media content between nodes on a network according to claim 1, wherein the determined value for the one or more storing nodes is further based upon the number of nodes each of the one or more storing nodes supplies with data packets.

17. The method for streaming media content between nodes on a network according to claim 1, further comprising the target node storing data of media content in a local memory buffer in the form of one or more data packets received from the one or more storing nodes so that the target node is operable to serve other nodes with the data packets and thereby perform the function of a storing node.

18. Apparatus for streaming media content, the apparatus comprising:
a memory;
one or more processors;
one or more network interfaces;
wherein one or more modules are stored in the memory and configured for execution by the one or more processors, the one or more modules comprising instructions for:
requesting data packets from a first further apparatus for streaming media content;
determining a value of the first further apparatus for streaming media content at least partly based on the number of data packets requested of the first further apparatus for streaming media content relative to the number of requested data packets received from the first further apparatus for streaming media content over a period of time;
storing the received data packets in a local memory buffer;
listening to a port of the network interface for a data packet request from a second further apparatus for streaming media content; and
sending the requested data packets to the second further apparatus for streaming media content.

19. Apparatus for implementing the method according to claim 1.

20. A system for streaming media content between nodes on a network, the system comprising:
a plurality of storing nodes storing media content data in a local memory buffer in the form of one or more data packets so that the storing nodes are operable to serve other nodes with the data packets;
a target node operable to request one or more data packets from one or more of the plurality of storing nodes;
wherein the target node determines and stores in memory a quality of service value relating to the quality of each of the one or more storing nodes, said quality of service value being at least partly based upon the number of data packets requested of a storing node relative to the number of requested data packets received from the storing node; and
the target node using the determined quality of service value for the one or more storing nodes to determine which storing nodes to send subsequent data packet requests.

21. The system as claimed in claim 20, wherein two or more apparatus are configured to receive data from an originating source.

22. The system as claimed in claim 21, wherein the originating source is a satellite receiver.
